(19) United States
(12) Patent Application Publication
(10) Pub. No.: US 2020/0080410 A1
(43) Pub. Date: Mar. 12, 2020

(54) WELLBORE DRILLING

(71) Applicant: SEKAL AS, Sandnes (NO)

(72) Inventor: Thomas KJOSMOEN, Sola (NO)

(21) Appl. No.: 16/126,495

(22) Filed: Sep. 10, 2018

(51) Int. Cl. E21B 44/04; E21B 47/04; E21B 47/06; G01V 99/00

(52) U.S. Cl. CPC E21B 44/04; G01V 99/005; E21B 47/06; E21B 47/042

(57) ABSTRACT

A method of issuing notifications for controlling drilling of a wellbore involves receiving real sensor data from the drilling rig and modelling the drilling of the wellbore by the drilling rig using a mathematical model. Modelled sensor data is extracted from the mathematical model and the real sensor data is analysed using the modelled sensor data. Notifications are generated based on the analysis.

### FIELD OF THE DISCLOSURE

The present disclosure relates to wellbore drilling. More specifically, the disclosure relates to a method of issuing notifications for controlling drilling of a wellbore and to a wellbore drilling apparatus implementing the method.

### BACKGROUND TO THE DISCLOSURE

Wellbore drilling, and particularly offshore wellbore drilling, involves a number of operational and safety challenges. These result in part from the relatively harsh environmental conditions present at typical drilling locations. As easily accessible oil and gas reserves are depleted, there is also a need to drill more wellbores that are longer, deeper or located in more geologically complex formations. Other challenges arise from the complexity and scale of the equipment and process involved in drilling the wellbore.

Automated systems for assisting drilling personnel with the drilling process are known. However, these each have their flaws. Some systems automatically override commands of the personnel controlling a drilling rig when certain conditions are detected, such as, say, an excess of pressure in a pipe. Although this can improve safety, such systems do not take account of conditions across the entire drilling process, and can cause unnecessary interruptions in drilling. Other systems simply provide information and alerts to the personnel controlling the drilling rig concerning the status of the drilling rig and wellbore. These systems generally to use only basic techniques for detecting each different aspect of the status of the drill rig and well bore, and tend to produce an excess of alerts. The personnel controlling the drill rig are therefore overwhelmed with information and alerts, and are unable to make reliable decisions

### SUMMARY OF THE DISCLOSURE

Aspects and embodiments of the present disclosure are set out in the appended claims. These and other aspects and embodiments of the disclosure are also described herein.

According to at least one aspect described herein, there is provided a computer-implemented method of issuing notifications for controlling drilling of a wellbore by a drilling rig, the method comprising: receiving real sensor data from the drilling rig; modelling the drilling of the wellbore by the drilling rig using a mathematical model and extracting modelled sensor data from the mathematical model; analysing the real sensor data using the modelled sensor data; generating notifications based on the analysis.

Preferably, the real sensor data relates to one or more of a list comprising: drill string torque; pump rate; hook load; down-hole pressure; stand pipe pressure; and mud pit level.

Preferably, the computer-implemented method further comprises determining friction in different parts of the drilling rig and providing the determined friction for each part of the drilling rig as the real sensor data.

Preferably, the computer-implemented method further comprises filtering the real sensor data to remove real sensor data relating to the drilling rig performing anomalous operations.

Preferably, the data relating to the drilling rig performing anomalous operations comprises one or more of a list including: drill string torque when a drill string of the drilling rig is held in slips; drill string torque when a drill bit of the drilling rig is at less than a predetermined depth in the wellbore; stand pipe pressure when flow rate in the stand pipe in less than a predetermined flow rate; and real sensor data received before the mathematical model has stabilised.

Preferably, the data relating to the drilling rig performing anomalous operations comprises one or more of a list including: real sensor data received when a drill string is advancing at an unsteady rate; and real sensor data received during downlinking.

Preferably, the computer-implemented method further comprises buffering the received real sensor data to allow time to determine that the drill rig is performing the anomalous operation.

Preferably, the analysing comprises calculating one or more statistical parameters.

Preferably, the statistical parameters are from a list including: mean; variance; skewness; kurtosis; and linear regressions.

Preferably, the analysing comprises comparing the real sensor data received during a first period of time with the real sensor data received during a second period of time, different from the first period of time.

Preferably, the generating of the notification comprises comparing the generated notification to previously generated notifications and discarding the generated notification if a previously generated notification has been issued for a similar topic within a predetermined time period.

According to another aspect described herein, there is provided a non-transitory computer readable medium having stored thereon instructions for carrying out the aforesaid method.

According to another aspect described herein, there is provided a computing device for issuing notifications for controlling drilling of a wellbore by a drilling rig, comprising a processor adapted to: receive real sensor data from the drilling rig; model the drilling of the wellbore by the drilling rig using a mathematical model and extract modelled sensor data from the mathematical model; analyse the real sensor data using the modelled sensor data; generate notifications based on the analysis.

Any apparatus feature as described herein may also be provided as a method feature, and vice versa. As used herein, means plus function features may be expressed alternatively in terms of their corresponding structure.

Any feature in one aspect of the disclosure may be applied to other aspects of the disclosure, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the disclosure can be implemented and/or supplied and/or used independently.

The disclosure also provides a computer program or a computer program product for carrying out any of the methods described herein, and/or for embodying any of the apparatus features described herein, and a computer readable medium having stored thereon a program for carrying out any of the methods described herein and/or for embodying any of the apparatus features described herein.

The disclosure also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Any feature in one aspect of the disclosure may be applied to other aspects of the disclosure, in any appropriate combination. In particular, method aspects may be applied to apparatus aspects, and vice versa. As used herein, means plus function features may be expressed alternatively in terms of their corresponding structure, such as a suitably programmed processor and associated memory.

Furthermore, features implanted in hardware may generally be implemented in software, and vice versa. Any reference to software and hardware features herein should be construed accordingly.

The disclosure extends to methods, system and apparatus substantially as herein described and/or as illustrated with reference to the accompanying figures.

Detailed embodiments are now be described, by way of example only, and with reference to the accompanying drawings.

### BRIEF DESCRIPTION OF THE DRAWINGS

FIG. 1 is a drilling rig used to drill a wellbore.

FIG. 2 is an illustration of a computer apparatus for issuing notifications for controlling drilling of the wellbore.

FIG. 3 is an illustration of a computer device on which different elements of the computer apparatus of FIG. 2 are implemented.

FIG. 4 is an overview of the four aspects of the method of the disclosure.

FIG. 5 is an illustration of the first aspect of the method of the disclosure.

FIG. 6 is an illustration of the second aspect of the method of the disclosure.

FIG. 7 is an illustration of the third aspect of the method of the disclosure.

FIG. 8 is an illustration of the fourth aspect of the method of the disclosure.

### DETAILED DESCRIPTION OF EMBODIMENTS

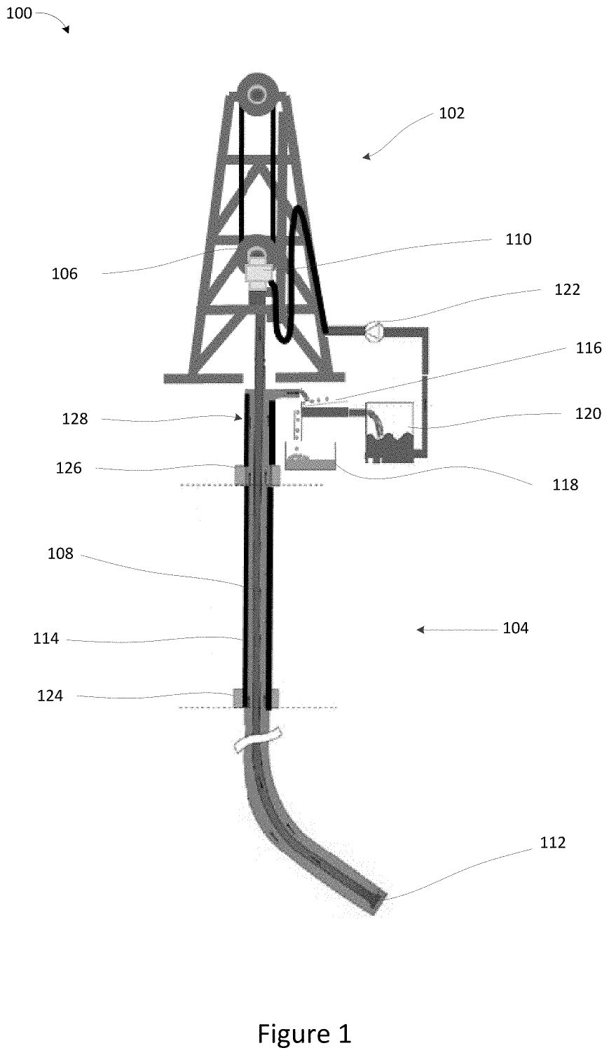

Referring to FIG. 1, a drilling rig 102 is used to drill a wellbore 104. The drilling rig 102 has a hoisting system 106 which controls the axial movement of a drill string 108 within the wellbore 104 by acting against the weight of the drill string 108. Rotational movement of the drill string 108 is controlled by a top drive 110. The top drive 110 rotates the drill string 108 while drilling.

A pumping system circulates drilling fluid down, through the drill string 108, to a drill bit 112. An annulus which is formed between the drill string 108 and a casing 114 provides a return path for the fluid. Once the fluid returns to the surface it passes over a shale shaker 116, which separates cuttings from the drilling fluid. The cuttings are the pieces of rock or earth that are extracted by the drilling and are transferred to the cuttings container 118. The drilling fluid flows into a mud pit 120, where the cuttings are separated from the drilling fluid. A mud pump 122 then pumps the drilling fluid from the mud pit 120 back down the drill string 108 to complete the circulation.

A blow out preventer 124 is positioned so that it can cut across the wellbore 104 and block the outflow of matter from the wellbore 104 in a critical situation. At the end of the casing 114 there is a casing shoe 126, underneath which there is an open hole section. For a subsea drilling system, there may also be a riser 128, which provides an extension of the well from the well top to the drilling rig 102.

The drilling rig 102 comprises a plurality of sensors which are arranged to measure various parameters. The drilling rig 102 typically has several hundred sensors monitoring the drilling operations at the surface. These sensors have a high refresh rate. The drilling system 102 typically also has sensors within the wellbore 104 itself, which are usually located close to the drill bit 112. These sensors have a lower refresh rate.

In more detail, the hoisting system 106 has hook load sensors, block position sensors and block velocity sensors, the top drive 110 has speed and torque sensors, the drill string 108 or drill bit 112 have downhole pressure and temperature sensors. Sensors are also arranged to measure the cuttings return flow. In particular, the mud pit 120 has sensors which measure the volume, temperature, density and rheology of the returning drilling fluid, and the mud pump 122 has flow rate and pressure sensors. Sensors are also arranged to measure tension and torsion exerted on the drill pipe, and a calliper may be used to measure dimensions of the drill pipe.

One significant parameter of the drilling rig 102 that is measured by the sensors is the flow rate of the returning drilling fluid (referred to as ‘return flow’). When the fluid returns to the surface through the annulus (as previously described), it flows through some troughs and pipes before it is transferred to the mud pit 120. Once the pumps are stopped, there is a delay before the volume of fluid in the mud pit 120 stops increasing due to the length and the angles of the pipes and troughs. This residual increase in the volume of the drilling fluid in the mud pit 120 has a certain pattern which can be analysed in order to detect detrimental events. Return flow data is also useful for the detecting whether there is an influx of fluid or gas influx to the wellbore 104, or if there is a fluid loss from the wellbore 104 (by measuring whether the volume of fluid returning to the mud pit 120 is higher or lower than expected). This method can also be used to detect issues with the transport of the cuttings due to the fact that the cuttings displace the drilling fluid.

Another significant parameter of the drilling rig 102 is friction. Friction is calculated as a normalised physical equivalent to represent the state of the drilling rig 102. Multiple types of friction are calculated, for example rotational friction (friction between the drill string 108 and the walls of the wellbore 104) or annulus friction (hydraulic friction through the annulus). Taking the annulus friction as an example, pressure measurements from within the wellbore 104 are taken together with pump rate, standpipe pressure (SPP) and other parameters, to calculate a single friction value that represents the hydraulic friction through the annulus. The frictions are calculated to be dimensionless so that two friction values can be compared to one another even when the inputs to the drilling rig 102, which inputs inform the processes that make changes to the drilling rig 102, are variable.

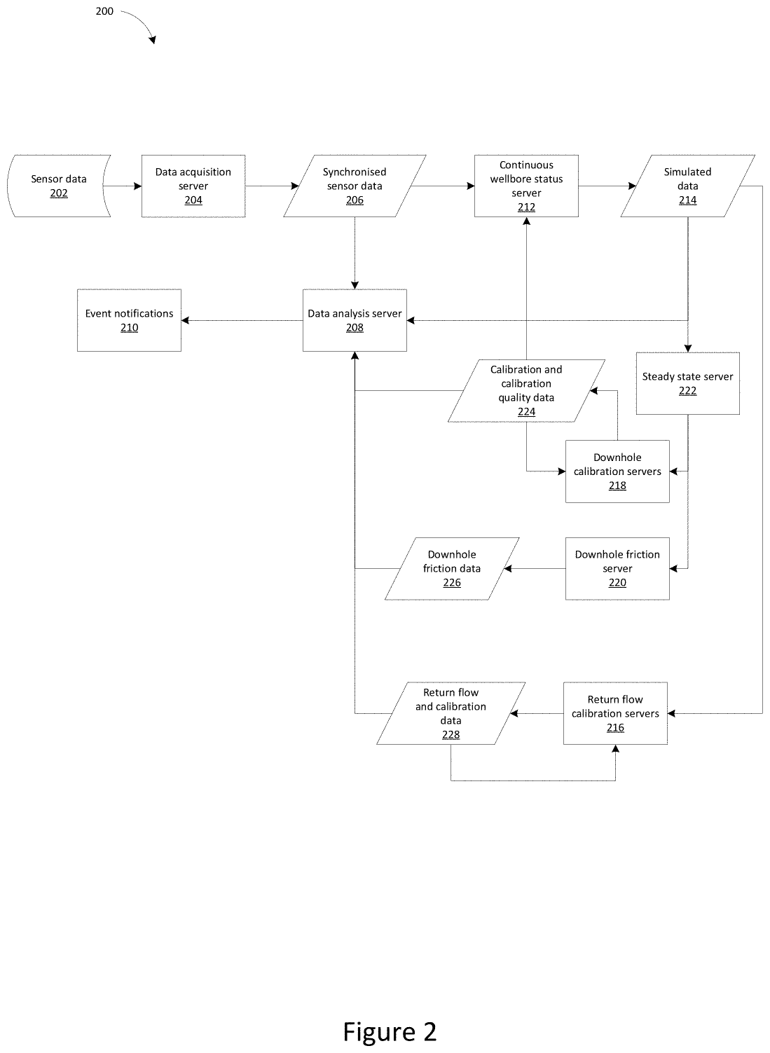

Referring to FIG. 2, computer apparatus 200 for processing and analysing data measured by the sensors of the drilling rig 102 is shown. In the computer apparatus 200, sensor data 202 measured by sensors of the drilling rig 102 and wellbore 104 are transmitted to a data acquisition stage 204. The sensors are arranged to measure data relating to a plurality of parameters of the drilling rig 102. These parameters relate to inputs to the drilling rig 102 and/or to the effects of those inputs. An example of an input is the depth of the drill string 108, and examples of the parameters which are affected by the inputs include wellbore pressure, wellbore temperature, hook load, or cuttings return flow rate.

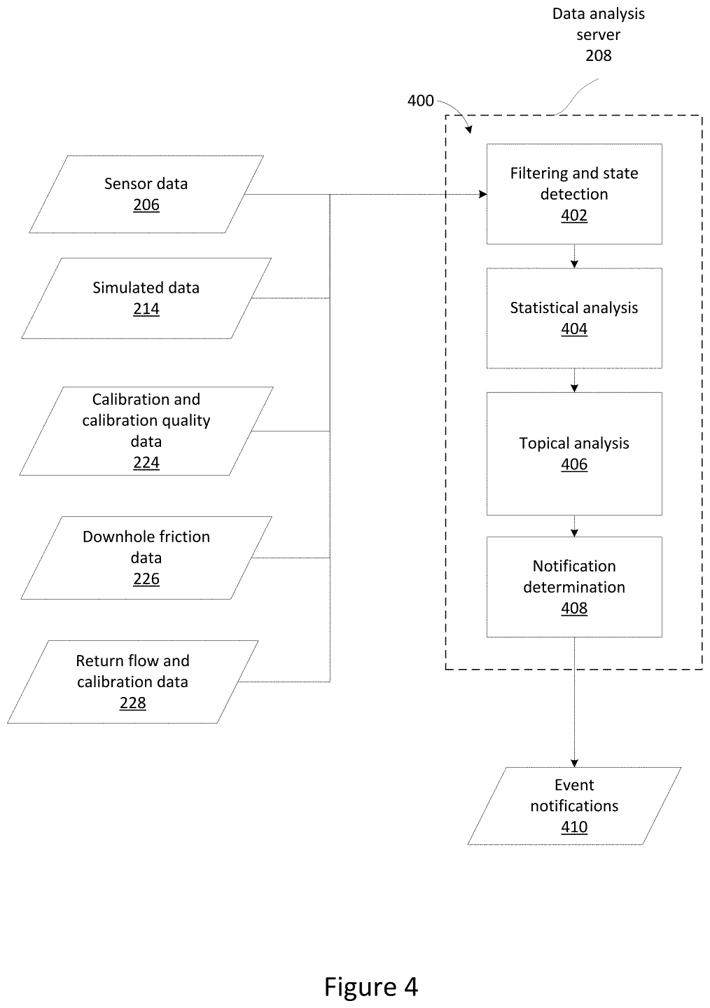

For remote monitoring, the sensor data 202 is acquired in bulks which can be unsynchronised. The data acquisition stage 204 processes and synchronises the sensor data 202, so that sensor data 202 collected at the same time are synchronised together. The synchronised sensor data 206 is transmitted to a data analysis stage 208. The data analysis stage 208 performs a data analysis method, which is described with reference to FIGS. 4 to 8, to identify statistics, patterns and trends of the data thereby to detect the occurrence of detrimental events and to issue notifications 210 of such detrimental events.

The sensor data 206 is also transmitted to the continuous wellbore status stage 212. The continuous wellbore status stage 212 generates simulated data 214 from physical models for both downhole and topside systems. The simulated data 214 is transmitted to the data analysis stage 208.

The physical models are advanced mathematical models of the drilling rig 102 and wellbore 104 (for example hydraulic models and drill string models). The physical models produce simulated data 214, which is in effect a virtual measurement of a parameter such as standpipe pressure (SPP), hook load, rotational torque, or down-hole pressure. Therefore, the simulated data 214 represents the expected or ideal behaviour of a parameter given the conditions elsewhere in the drilling rig 102 and wellbore 104. Therefore, the simulated data 214 provides a reference against which the measured parameters can be compared in order to determine whether a parameter measured by the sensors is diverging from the models. In this way, trends in the sensor data away from the simulated data (indicating that a detrimental event is about to occur) are identified and a drill operator is notified so can take action to avert the detrimental event.

The physical models only match reality if they are calibrated according to the present conditions of the drilling rig 102 and wellbore 104. The calibration uses sampling and optimisation methods, and the calibration process runs throughout the drilling operation. If the calibration is recurrently performed, gradual changes in the sensor measurements can cause gradual changes in the calibration factors. This gradual drifting of calibration factors can mask real issues by causing the models to match the real sensor measurements when they in fact should not. Therefore when calibrating the physical models, the calibration data is collected and analysed in order to identify any trends.

The simulated data 214 is transmitted to the return flow calibration stages 216 directly, and to the downhole calibration stages 218 and the downhole friction stage 220 via the steady state stage 222. In order to perform a calibration, steady-state measurements from the drilling system must be made. A steady-state measurement is a measurement of a parameter (such as SPP) over a short period of time when the inputs (such as the drill string) are steady. Each steady-state measurement will contain noise. This noise could be random variations in the amplitude of the data or it could be ordered in the form of a slope or a curve. This noise is taken into account when evaluating the significance of a sensor measurement and is used in the calibration process. The noisier the measurement is, the less weight it will have in the calibration process.

The downhole calibration stages 218 output calibration data and data on the quality of that calibration 224 which is fed back to the stages 218. The downhole friction stage 220 outputs downhole friction data 226. The return flow calibration stages 216 output return flow and calibration data 228 which is fed back to the return flow calibration stage 216. The data 224, 226, 228 output from the downhole calibration stages 216, downhole friction stage, 218, and return flow calibration stages 220 are transmitted to the data analysis stage 208.

The best calibration is the calibration which makes the error between the model and reality as small as possible. The calibration error will give an indication of the calibration quality which is essentially a measure of how well the model matches reality. If there are many data points that are significantly different to the model or if there are an insufficient number of data points, the calibration quality is typically poor. If the calibration quality is poor, comparing the simulated data to the measured data would potentially yield inaccurate results.

The data analysis stage 208 receives the sensor data 206, the simulated data 214 generated by the physical models, and the data 224, 226, 228 output from the downhole calibration stages 216, downhole friction stage 218, and return flow calibration stages 220. The data analysis stage 208 analyses these inputs to detect detrimental events and to decide whether an event notification 210 should be issued.

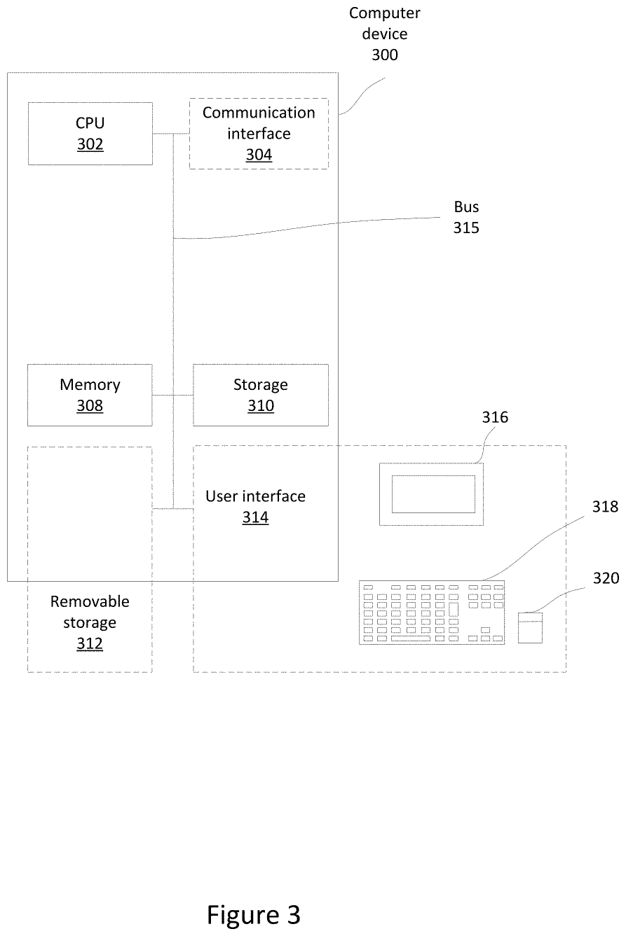

Referring to FIG. 3, the described methods of processing and analysing the sensor data 206 are implemented on a computer device 300. In some embodiments, the computer apparatus 200 described with reference to FIG. 2 is implemented on a single computer device 300. In other embodiments, multiple computer devices 200 in communication with one another via a computer network are used to implement the computer apparatus.

The computer device 300 comprises a processor in the form of a CPU 302, a communication interface 304, a memory 308, storage 310, removable storage 312 and a user interface 314 coupled to one another by a bus 315. The user interface 314 comprises a display 316 and an input/output device, which in this embodiment is a keyboard 318 and a mouse 320. In other embodiments, the input/output device comprises a touchscreen.

The CPU 302 executes instructions, including instructions stored in the memory 308, the storage 310 and/or removable storage 312.

The memory 308 stores instructions and other information for use by the CPU 302. The memory 308 is the main memory of the computer device 300. It usually comprises both Random Access Memory (RAM) and Read Only Memory (ROM).

The storage 310 provides mass storage for the computer device 300. In different implementations, the storage 310 is an integral storage device in the form of a hard disk device, a flash memory or some other similar solid state memory device, or an array of such devices.

The removable storage 312 provides auxiliary storage for the computer device 300. In different implementations, the removable storage 312 is a storage medium for a removable storage device, such as an optical disk, for example a Digital Versatile Disk (DVD), a portable flash drive or some other similar portable solid state memory device, or an array of such devices. In other embodiments, the removable storage 312 is remote from the computer device 300, and comprises a network storage device or a cloud-based storage device.

A computer program product is provided that includes instructions for carrying out aspects of the method(s) described herein. The computer program product is stored, at different stages, in any one of the memory 308, storage device 310 and removable storage 312. The storage of the computer program product is non-transitory, except when instructions included in the computer program product are being executed by the CPU 302, in which case the instructions are sometimes stored temporarily in the CPU 302 or memory 308. It should also be noted that the removable storage 312 is removable from the computer device 300, such that the computer program product is held separately from the computer device 300 from time to time.

The communication interface 304 is typically an Ethernet network adaptor coupling the bus 315 to an Ethernet socket. The Ethernet socket is coupled to a network.

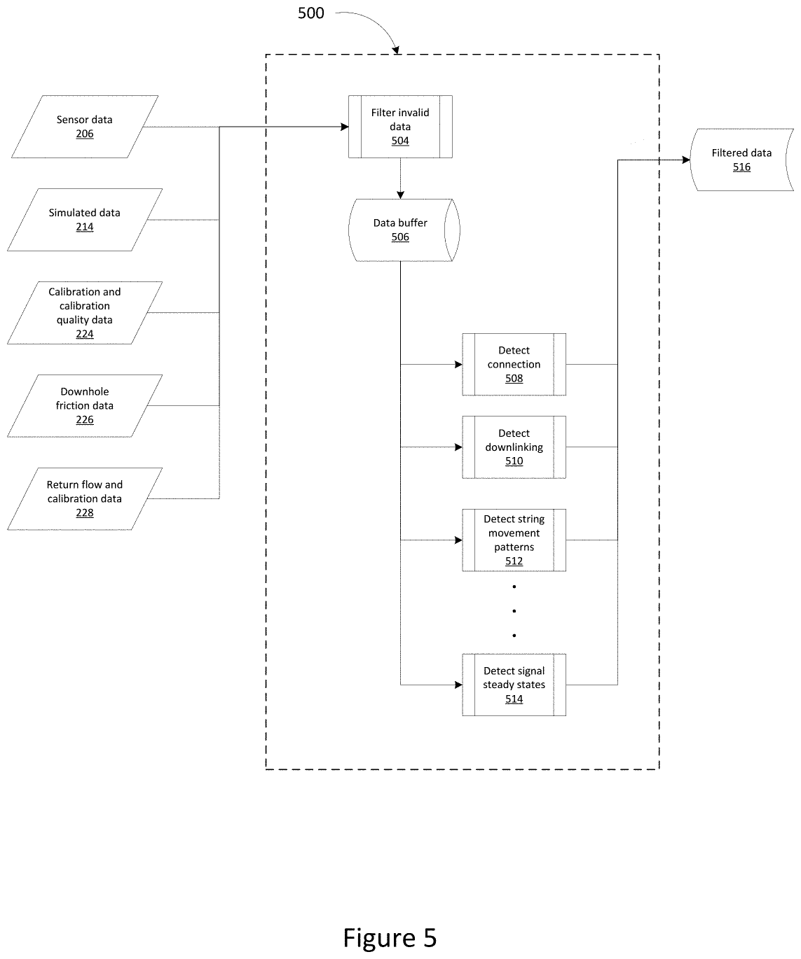

Referring to FIG. 4, the data analysis method performed on the data analysis stage 208 of FIG. 2 is illustrated by way of a flowchart. In summary, the data analysis stage 208 receives data inputs 206, 214, 224, 226, and 228 and performs a method 400 of data analysis which broadly comprises four stages: filtering and state detection 402; statistical analysis 404; topical analysis 406; and notification determination 408. The result of the data analysis method 400 is the issuance of event notifications 410. Each of these four stages will be described in more detail with reference to FIGS. 5 to 8 respectively.

The first stage of filtering and state (or feature) detection 402 filters the data measured by the sensors. The filtering removes unwanted artefacts in the data and is performed in two phases. In the first phase invalid data is removed and in the second phase the data is filtered in dependence on the state of the drilling operation to remove, for example, the effects of down-link signals, connections, and/or lift-slack sequences from the data.

The second stage of statistical analysis 404 uses a data buffer that stores the filtered sensor data and simulated data from the physical models. The statistical analysis computes statistical measures of the filtered sensor data.

The third stage of topical analysis 406 assembles the various statistical measures and compares them to the threshold in order to assess whether a certain topic (which is an aspect of the drilling system), for example standpipe pressure (SPP), is exhibiting behaviour that is classified as a detrimental event and would therefore warrant a notification.

The fourth stage of notification determination 408 decides when an event notification 410 should be issued, and what notification to issue, based on the results of the topical analysis and on the presence of existing notifications.

Referring to FIG. 5, the filtering and state detection stage 402 of the method is illustrated by way of the flowchart 500.

The data associated with drilling operations are often erratic, contain erroneous data, and describe complex operations. This erroneous data can be misinterpreted as a detrimental event and a ‘false positive’ notification can be issued to the user. In order to ameliorate this problem and issue accurate notifications to the user, the input data is filtered so as to remove unwanted artefacts.

The filtering and state detection stage 402 comprises two steps. In the first step, the input data 206, 214, 224, 226, and 228 is filtered to remove values that are undefined or invalid 504, for example negative pressure readings from a pressure sensor in the wellbore. In this way, the number ‘false positive’ notifications issued by the system is reduced.

The filtered data is then stored in a data buffer 506, which is preferably an offset circular buffer, before being filtered in accordance with a second filtering step. In the second step, the data is filtered based on the state of the relevant wellbore drilling machinery according to a set of rules based filters 508 to 514. The filtered data 516 is then output for the next stage of analysis.

The reason for this second step of filtering is that, during certain drilling operations, the data measured by some sensors of the drilling rig or wellbore may not be meaningful and can trigger the issuance of erroneous notifications.

In one example, a drill string torque sensor may be arranged to measure the rotational torque exerted on the drill string by the top drive. Exerting excessive torque on the drill string during drilling can cause damage to the drill string. Therefore, it is desirable to notify a drill operator in the event that excessive torque is being applied to the drill string. However, simply issuing a notification to the drill operator when the torque applied to the drill string exceeds a certain torque threshold would result in notifications being issued in cases where it is actually safe to apply high torques.

Therefore, the sensor data is interpreted in light of the current drilling operation. In the above example, it is important to know whether the drill string is freely hanging in the top drive or if it is held firmly in the slips in order to determine whether the torque being applied to the drill string is actually excessive. In the latter case, the slips do not allow for rotational movement of the drill string so a much higher torque may be safely applied (either to break or make the drill string connections) than would be allowed during normal drilling. Furthermore, when the drill string is held in the slips neither the rotation of the top drive nor movement of the block have any effect on the drill string and downhole conditions. Therefore, in order to avoid unnecessary notifications, the measurements of rotational torque are filtered out and discarded during the time period where the drill string is held in the slips.

As previously described, the second filtering step uses a set of rule-based filters 508 to 514 to determine when data should be discarded. The rules based filters require the system to meet certain conditions before sensor data is analysed. The rules based filters may also include thresholds for minimum values or out-of-bound values for certain parameters being measured by the sensors. Some examples of the rules based filters are:
Measurements of drill string torque collected while the drill string is held in the slips should be discarded. The reason for this rule is detailed above.
Data analysis should not begin until the drill bit is at a certain depth (typically around 200 m). Therefore, sensor data measured before the drill bit reaches the certain depth is discarded. The reason for this rule is that sensor data measured while assembling the bottom hole assembly (BHA) for insertion into the well is of little to no use but can cause the issuance or inaccurate or unnecessary notifications.
Data analysis should not begin until a certain flow rate is reached. Therefore, sensor data measured before the certain flow rate is reached is discarded. The reason for this rule is that it is not possible to accurately model standpipe pressure (SPP) below the certain flow rate. Comparing sensor data to an inaccurate model would lead to the issuance of inaccurate notifications.
If the physical models have recently started, sensor data should be discarded until the models have stabilised. Comparing sensor data to an unstable model would lead to the issuance of inaccurate notifications.

As well as the abovementioned rule-based filters 508 to 514, the data is filtered by recognising certain signatures in the data. Some examples of the signature recognition filters are:
Analysing the movement of the block and the drill bit to make sure they move at a pace which is sufficiently steady that the friction measurements are accurate. The reason for this filter is that certain analysis must only be performed on data which has been measured while the drill string is moving steadily (if it is not moving steadily the measured data will be misleading).
Analysing flow rates, modelled SPP, and actual SPP measured by the sensors to detect downlinking. Downlinking is the process of sending messages to the electronics in the drill string bottom hole assembly (BHA) and is usually done by coding signals into the mud pulse from the top side to be received at the BHA. The quality of certain sensor data, such as Equivalent Circulation Density (ECD) data, will be negatively affected by downlinking.

The purpose of the data buffer 506 is to postpone the onward processing of the data. The reason for postponing the processing of the data is to allow for the identification of drilling procedures which make sensor data unfit for analysis or modelling, so that that data can be discarded. One example of such a procedure is when the drill string is held in the slips.

It is very rare that a drilling rig has the functionality to generate a signal when, for example, the drill string is going into the slips, therefore the available sensor data (such as block position and hook load) must be used to identify when this is happening. However, this introduces a further problem that the unfit data will have already been caused the abovementioned problems by the time that determination is made. The data buffer 506 ameliorates these problems by delaying the onward processing of the sensor data collected at a certain instant in time, so that data which is unfit for onward processing can be identified and discarded before it is analysed in the remaining stages of the data analysis method. In one example, the processing of block position and hook load sensor data is delayed by the data buffer 506 for 30 seconds to allow for detection of patterns in the data that indicate that the drill string is going into the slips. One way in which such patterns are detected is by comparing the delayed data held in the buffer 506 against the data measured in real time to identify any significant changes. If such patterns are detected, the data is not forwarded from the data butter 506 to be analysed. In this way, unfit data is not analysed so cannot cause unnecessary notifications.

After the filtering and state detection stage, the filtered data 516 is then processed in accordance with the second stage of statistical analysis.

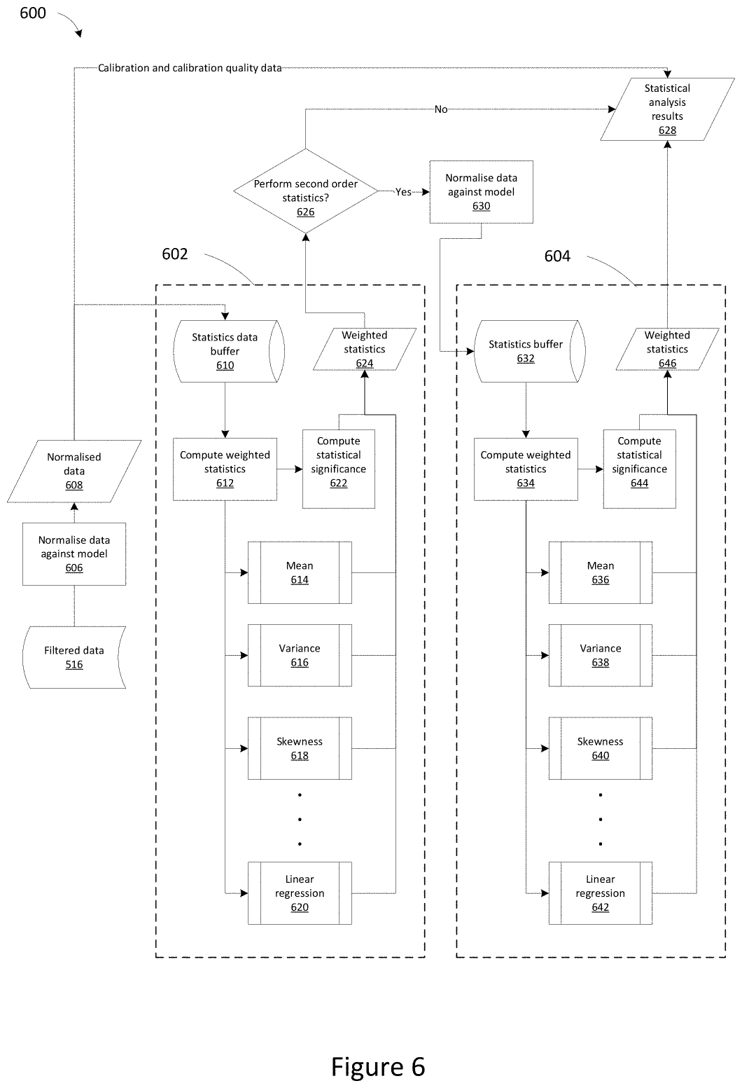

Referring to FIG. 6, the filtered data 516 is statistically analysed according to the second stage 404 of the method. The statistical analysis 600 comprises first order analysis 602 and second order analysis 604. At the first statistical analysis step 606, filtered data 516 may be normalised against simulated data generated by the physical models. The normalised data 608 it is then transmitted to, and stored by, the statistics data buffer 610. Normalising the measured data against the simulated data provides a measure of how closely the drilling behaviour agrees with the physical models, and therefore allows for trending of the divergence of the measured data from the model data. Alternatively, the filtered data 516 may be transmitted directly to the statistics data buffer 610 without normalisation, for example in the case where the measurement noise is being evaluated as opposed to the ambient level.

Once the statistics data buffer 610 buffer has a sufficient amount of data, the data is statistically analysed in order to calculate a range of statistical measures of the data. For some types of sensor measurements, only a single sample of sensor data is analysed in order to calculate a statistical measure whereas for other types of sensor measurements, the statistics data buffer 610 must contain a minimum amount of data, for example half an hour's worth of data, before any statistical analysis can be performed. The statistics data buffer 610 also ensures that the data is sufficiently spread out in a given time window such that a time window of a given length does actually contain data spanning the entire time window.

The statistical analysis is performed on sensor data collected during one or more specific time intervals. Performing statistical analysis on data collected during one or more specific time intervals allows for a single time or depth window to be used as a basis for analysis. Alternatively, two separate specific intervals can be compared with one another. In one example, changes in torque noise behaviour are compared over time by statistically analysing the two time intervals and the difference between them.

The statistical analysis is also performed on sensor data collected during a dynamic time window. A dynamic time window contains multiple time intervals between two points in time. The results of the statistical analysis therefore are represented as vectors where each element is the statistical result for each interval of time within a dynamic window. In one example, the linear regression slope data is a vector describing how the linear regression develops as a function of time. This approach allows for an analysis of trends ranging from short to long term and enables issuing notifications on variable-length trends.

Weighted statistics 612 are calculated for data collected during each time interval. Examples of such statistical measures include mean 614, variance 616, skewness 618, kurtosis (not shown), and linear regressions 620. The calculations are weighted against the statistical significance 622 of each sample, which is a combination of physical measurement uncertainty associated with the sensors, calibration quality, and sample quality. This weighting ensures that low quality data samples carry a lower weight than high quality samples. The weighted statistics are then output 624.

At step 626, a second order statistical analysis 604 is optionally performed, in which case steps 630 to 646 (which are equivalent to steps 606 to 624) are performed. The second order statistical analysis generates new statistical information which can be used to detect trends in data without having to do a comparison with the modelled data. The input for the second order statistical analysis is the relationship between the statistical measures computed in respect of the data collected during two separate time intervals. Alternatively, the relationship between the two time intervals can also be used as an input to a second order statistical analysis.

In addition to the computed statistical measures, an additional computation is made as to the likelihood that an identified trend is real. This likelihood computation takes into account how many samples were used to calculate the statistical measures for the data in each time interval and computes the significance of the particular statistical measure. Computing the likelihood that an identified trend is real provides a parameter which can be compared against a threshold, so that a trend must be likely to be real before a notification is issued. In this way, a situation where inaccurate results are obtained from very few samples or noisy data may be avoided.

The results 628 of the statistical analysis stage are then processed according to the third stage of topical analysis.

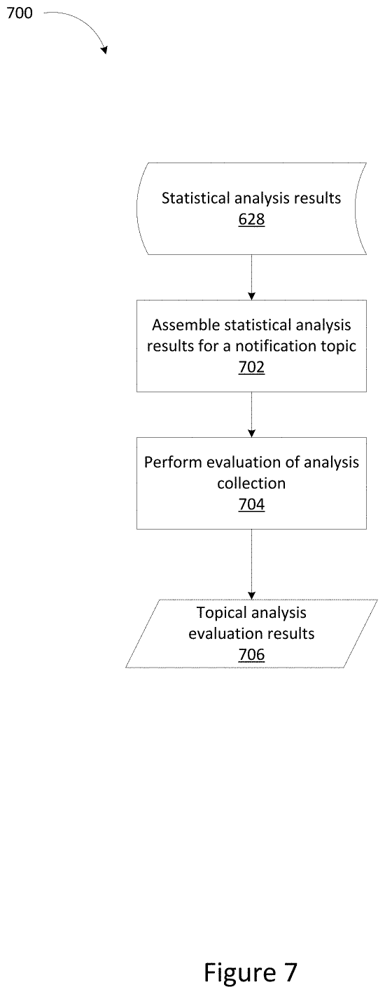

Referring to FIG. 7, the results of the statistical analysis 628 are analysed in accordance with the third stage 406 of the method. The third stage of the method is a topical analysis 700 of the results of the statistical analysis in order to identify detrimental events. Detrimental events are when one or more statistical measure diverges significantly from the modelled data.

Referring to FIG. 7, the statistical analysis results 628 are assembled for a certain notification topic in step 702. Notifications may be issued on a wide range of topics (for example a standpipe pressure (SPP) or pack-off detection notification) and each notification topic has separate thresholds against which statistical measures are compared in order to determine whether notifications should be issued. Some notification topics depend on just one parameter, such as an SPP notification, whereas other notification topics depend on many parameters, such as pack-off detection. Therefore, the statistical analysis of each parameter which must be considered for a given notification topic must be assembled.

The assembled statistical analysis results are then evaluated using thresholds or thresholding functions at step 704 (this step may use for example a Fuzzy Logic approach or a non-linear function describing the threshold as a function of time or depth).

The normalisation of the sensor data in the statistical analysis generates a percentage deviation from the model. The exact point at which the divergence from the model becomes significant enough to warrant a notification is set by a threshold which is determined based on previous drilling operations where drilling issues have been encountered. The determination based on previous drilling operations can be done manually, by inspecting the statistical values and the behaviour during the drilling issues, or it can be done using machine learning on collections of the kind of drilling issues that should be detected.

Certain notification topics only require one particular statistical measure and one particular model in order to determine whether a notification should be issued, whereas other topics require multiple sources of statistical data and models to make that determination. For example, the SPP topic requires only the measured SPP data and modelled SPP data, whereas pack-off detection requires data from many sensors and models. When a notification topic depends on just one parameter, such as an SPP notification, the threshold above which a notification is issued is lower as it can be reliably determined whether the relevant parameter has exceeded that threshold. When a notification topic depends on many parameters, such as pack-off detection where one of the relevant parameters is SPP, the SPP threshold is higher as it is just one of many parameters which indicate a pack-off event. In this way, unnecessary notifications are avoided.

The results of the topical analysis 706 of all the notification topics are then output.

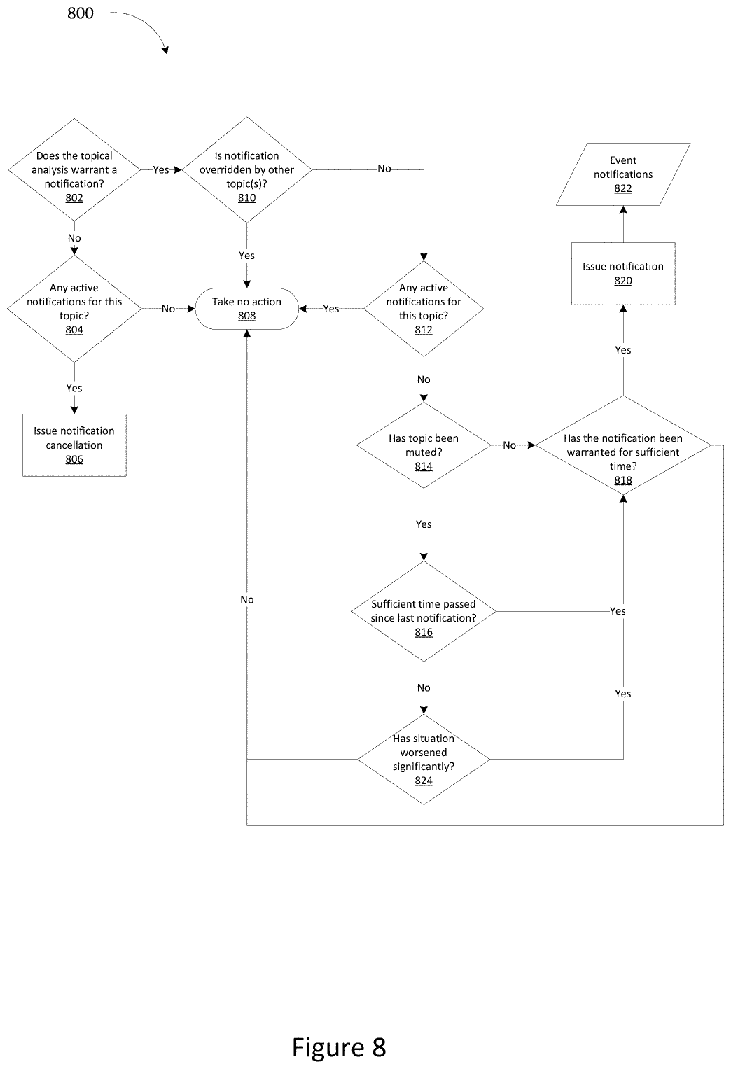

Referring to FIG. 8, the topical analysis results 706 are processed according to the fourth stage 408 of the method in order to determine whether a notification should be issued. Whilst it is determined in the third stage of topical analysis whether or not a notification for each single topic is warranted, the final determination as to whether a notification is actually issued depends on the following process.

If the topical analysis indicates that a notification for a given topic is warranted, a series of checks are performed before any notification is actually issued.

The first step 802 is to check whether the topical analysis evaluation warrants a notification. If not, then check whether there are currently any active notifications for this topic at step 804. If there are already active notifications for this topic, issue a notification cancellation 806 to cancel the active notification, if there are not already active notifications for this topic then take no action 808.

If the notification does relate to a new notification then, at step 810, check whether the notification is overridden by other topics. If it is, then take no action 808. Checking whether a notification is overridden by another topic means that particularly significant notifications, such as notifications about pack-off, supress any less significant notifications, such as a notification about SPP.

If the notification is not overridden by another topic, then check whether there are any active notifications for this topic at step 812. If there are already active notifications for this topic then take no action 808 as the recipient of the notifications does not need to be notified again. If there are not active notifications, then check whether notifications for this topic have been muted at step 814. Notifications can be muted by the recipient of the notifications in order to avoid excess notifications and, as is discussed below, the notifications are only unmuted at certain intervals and under certain conditions.

If the notifications for this topic have not been muted, then check whether the notification has been warranted for a sufficient amount of time at step 818. If the notification has been warranted for a sufficient duration of time, then issue an event notification 822 for this topic at step 820. In this way, the accuracy of the notifications is improved as notifications are not issued for short lived changes in a given parameter rather notifications are only issued when a threshold has been exceeded for a sufficient amount of time. What constitutes a sufficient amount of time depends on the type of issue or the parameters that are being considered.

If the notifications for this topic have been muted, check whether sufficient time has passed since the last notification at step 816, and if sufficient time has passed then also check whether the notification has been warranted for a sufficient duration of time 818. If the notification has been warranted for a sufficient duration of time, the notifications are unmuted and an event notification 822 is issued for this topic at step 820.

If sufficient time has not passed since the last notification, check at step 824 whether the situation has worsened significantly since the last notification, and then also check whether the notification has been warranted for a sufficient duration of time 818. If the notification has been warranted for a sufficient duration of time, the notifications are unmuted and an event notification 822 is issued for this topic. In one example, an event notification is reissued if the annulus friction increases by 10% since the issuance of the last notification.

If sufficient time has not passed since the last notification, and the situation has not worsened significantly, take no action. Similarly, if the notification has not been triggered for a sufficient duration of time, take no action.

In summary, a notification 822 with a topic, time stamp, and statistical information, is issued and propagated into the system if: a notification for the topic is warranted by the topical analysis; the notification topic has not been overridden by another topic; there are no active notifications for the topic; the notification topic has not been muted, or sufficient time has passed, or the situation has worsened significantly, since the last notification; and the notification has been warranted for a sufficient amount of time.

Once issued, the event notification 822 may be distributed to the drill operator on a dashboard of the drill operator's control panel, for example as a notification in a software program running on the drill operator's computer which may be located at the drilling rig or remotely from the drilling rig in an operation centre controlling the drilling operation. The notification may alternatively or additionally be distributed as an email or a text message pushed to the drill operator's computer or phone, or however the user chooses to distribute the notifications.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A computer-implemented method of issuing notifications for controlling drilling of a wellbore by a drilling rig, the method comprising:
receiving real sensor data from the drilling rig;
modelling the drilling of the wellbore by the drilling rig using a mathematical model and extracting modelled sensor data from the mathematical model;
analysing the real sensor data using the modelled sensor data;
generating notifications based on the analysis.

2. The computer-implemented method of claim 1, wherein the real sensor data relates to one or more of a list comprising:
drill string torque;
pump rate;
hook load;
down-hole pressure;
stand pipe pressure; and
mud pit level.

3. The computer-implemented method of claim 1, comprising determining friction in different parts of the drilling rig and providing the determined friction for each different part of the drilling rig as the real sensor data.

4. The computer-implemented method of claim 1, comprising filtering the real sensor data to remove real sensor data relating to the drilling rig performing anomalous operations.

5. The computer-implemented method of claim 4, wherein the real sensor data relating to the drilling rig performing anomalous operations is one or more of a list comprising:
drill string torque when a drill string of the drilling rig is held in slips;
drill string torque when a drill bit of the drilling rig is at less than a predetermined depth in the wellbore; and
stand pipe pressure when flow rate in the stand pipe in less than a predetermined flow rate.

6. The computer-implemented method of claim 4, wherein the real sensor data relating to the drilling rig performing anomalous operations is one or more of a list comprising:
real sensor data received when a drill string is advancing at an unsteady rate;
real sensor data received during downlinking;
real sensor data received before the mathematical model has stabilised.

7. The computer-implemented method of claim 4, comprising buffering the received real sensor data to allow time to determine that the drill rig is performing the anomalous operation.

8. The computer-implemented method of claim 1, wherein the analysing comprises calculating one or more statistical parameters.

9. The computer-implemented method of claim 8, wherein the statistical parameters are one or more of a list comprising:
mean;
variance;
skewness;
kurtosis; and
linear regressions.

10. The computer-implemented method of claim 1, wherein the analysing comprises comparing the real sensor data received during a first period of time with the real sensor data received during a second period of time, different from the first period of time.

11. The computer-implemented method of claim 1, wherein generating the notification comprises comparing the generated notification to previously generated notifications and discarding the generated notification if a previously generated notification has been issued for a similar topic within a predetermined time period.

12. A non-transitory computer readable medium having stored thereon instructions for carrying out the method of claim 1.

13. A computing device for issuing notifications for controlling drilling of a wellbore by a drilling rig, comprising a processor adapted to:
receive real sensor data from the drilling rig;
model the drilling of the wellbore by the drilling rig using a mathematical model and extract modelled sensor data from the mathematical model;
analyse the real sensor data using the modelled sensor data;
generate notifications based on the analysis.

14. The computer-implemented method of claim 5, comprising buffering the received real sensor data to allow time to determine that the drill rig is performing the anomalous operation.

15. The computer-implemented method of claim 6, comprising buffering the received real sensor data to allow time to determine that the drill rig is performing the anomalous operation.
